(19) United States
(12) Patent Application Publication
(10) Pub. No.: US 2013/0098910 A1
(43) Pub. Date: Apr. 25, 2013

(54) PORTABLE STORAGE RESERVOIR AND CONNECTOR

(71) Applicant: Cliff Edward Simpson, Ault, CO (US)

(72) Inventor: Cliff Edward Simpson, Ault, CO (US)

(21) Appl. No.: 13/280,417

(22) Filed: Oct. 25, 2011

(51) Int. Cl. B65D 25/00; F16B 5/00

(52) U.S. Cl. 220/9.4; 403/292

(57) ABSTRACT

A portable reservoir has a fence that encloses an area of a support surface and a liner that rest on the support surface, and extends across the area and up the inside of the fence. The fence is made up of a number of fence sections that are connected together by interleaving connectors with pins. The liner has clips that hook over the top of the fence sections to support the vertical part of the liner. A stile provides access to the inside of the reservoir. The reservoir can have a large capacity and can be used for storing liquids used in hydraulic fracturing.

### TECHNICAL FIELD

The present invention relates to liquid storage and more particularly to a portable, above ground storage reservoir.

### BACKGROUND ART

There are several known systems for relatively short term storage of large quantities of liquids such as water. One simple system includes digging a pit and lining the pit with a material impermeable to the liquid. Digging the pit can be time consuming and expensive. Generally, the pit must be fenced in to prevent people and animals from falling in. The pit can leak and such leaks may be hard to detect and correct. When the pit is no longer needed and has been disassembled, the ground underneath is often too soft for other uses.

Hydraulic fracturing is used to increase the rate of production of fluids such as oil, water and natural gas in wells, and requires large quantities of water and other liquids. Generally, the liquids are stored in semi-trailer sized tanks. A large number of these tanks are required. The tanks are expensive, and moving the tanks to and around the job site is expensive and time consuming.

Another portable system for storage of liquid is a large flexible bladder. These bladders can have the storage capacity of a number of semi-trailer sized tanks. The size of these bladders is limited to the folded, deflated size that can be loaded and transported by a vehicle. The height of these bladders is limited, since increasing the height increases the pressure the bladder must contain. As the pressure increases, the bladder material required becomes heavier and bulkier. Although bladders are currently available in up to about a 500,000 gallon size, the bladders are usually only about five feet high. Bladders require a much larger area than the semi-trailer sized tanks for the storage of an equivalent quantity of liquid.

A portable storage reservoir with a circular peripheral wall or fence enclosing and supporting a liner is currently being offered by Poseidon Concepts of Alberta, Canada. The fence consists of a plurality of fence sections connected together by connector plates with holes that fit over projections or bosses on fence sections. Canadian Patent No. 2,692,016 to Wiebe discloses the connector configuration. The fence sections are stacked on one or more trucks for transport. The liner is pulled over the upper edge of the fence and held with C-clamps.

### DISCLOSURE OF THE INVENTION

A portable reservoir for liquid storage includes a substantially circular fence, and a liner inside the fence. The fence has a plurality of rigid, portable fence sections. The fence sections each have a plate that curves from a first side edge to a second side edge and extends from a bottom edge to a top edge. The plate has a concave inner face and a spaced outer face. An elongated first vertical member is attached to the outer face at the first side edge, and a plurality of spaced first connector portions are attached to the outer face along the first side edge. An elongated second vertical member is attached to the outer face at the second side edge, and a plurality of spaced second connector portions are attached to the outer face along the second side edge opposite the first connector portions. Horizontal members are attached to the outer face, extending between the first and second connector portions, and along the bottom and top edges. The first and second connector portions each have a plurality of spaced horizontal leaves with the leaves of each first connector portion on one fence section interleaving with the leaves on a second connector portion on the adjacent fence section. Removable pins extending through vertical apertures in the leaves secure the fence sections together. The vertical spacing of the first connector portions increases from the bottom edge to the top edge. The liner has a liner body of a liquid impermeable material and a plurality of clips. The clips are spaced along the top edge of the fence sections to support the liner. The reservoir includes a stile having an inner stairway inside the reservoir, an outer stairway outside the reservoir and a bridge over the fence that connects the inner and outer stairways. The stile is suspended on the fence and provides access to the inside of the reservoir.

### BRIEF DESCRIPTION OF THE DRAWINGS

Details of this invention are described in connection with the accompanying drawings that bear similar reference numerals in which:

FIG. 1 is a perspective view of a reservoir embodying features of the present invention.

FIG. 2 is an outside elevation a fence section of the fence of the reservoir of FIG. 1.

FIG. 3 is a perspective view of a first connector portion of the fence section of FIG. 2.

FIG. 4 is a perspective view a second connector portion of the fence section of FIG. 2.

FIG. 5 is a side elevation view of a connector of the fence of the reservoir of FIG. 1.

FIG. 6 is a side perspective view of a pin for the connector of FIG. 5.

FIG. 7 is a partial inside elevation view of the reservoir of FIG. 1.

FIG. 8 is a sectional view taken along line 8-8 of FIG. 7.

FIG. 9 is an inside perspective view of a stile of the reservoir of FIG. 1, on a fence section.

FIG. 10 is a side perspective view of the stile of FIG. 9.

### DETAILED DESCRIPTION OF THE INVENTION

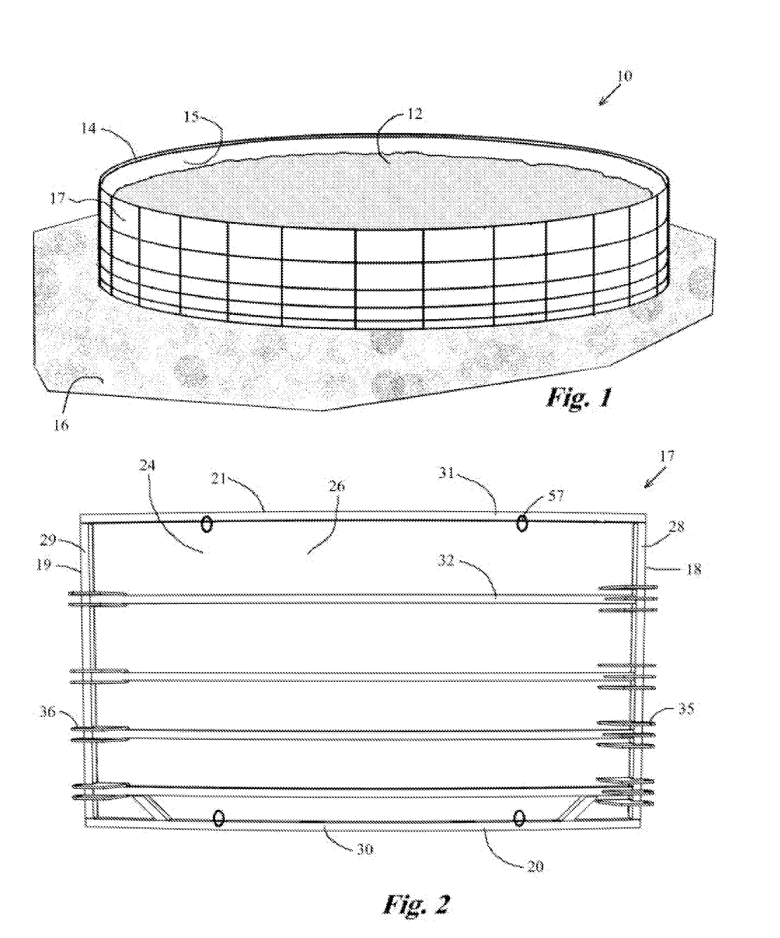

Referring to FIG. 1, a portable storage reservoir 10, embodying features of the present invention, includes a fence 14 and a liner 15. The reservoir 10 stores liquid 12 or other flowable material. The fence 14 has a plurality of fence sections 17 that are connected together on a support surface 16. The fence 14 encloses substantially circular area of the support surface 16. The support surface 16 is typically soil, and is preferably flattened before assembly of the reservoir 10.

As shown in FIG. 2, each fence section 17 has a rectangular shape, with a first side edge 18 and a spaced second side edge 19, and with a bottom edge 20 and a spaced top edge 21, each extending from the first side edge 18 to the second side edge 19.

Describing the specific embodiments herein chosen for illustrating the invention, certain terminology is used which will be recognized as being employed for convenience and having no limiting significance. For example, the terms “top” and “bottom” refer to the illustrated embodiment in its normal position of use. The terms “inner” and “outer” refer to direction relative to the center of the reservoir 10, and the terms “side”, “lateral” and “laterally outwardly” refer to direction transverse to a radius from the center of the reservoir 10. Further, all of the terminology above-defined includes derivatives of the word specifically mentioned and words of similar import.

Each fence section 17 has a plate 24 that extends from the first side edge 18 to the second side edge 19, and from the bottom edge 20 to the top edge 21. The plate 24 is of substantially uniform thickness, and has an inner face 25 and a spaced outer face 26. The plate 24 shown is steel plate. The plate 24 curves between the first and second side edges 18 and 19, such that the inner face 25 is concave and the outer face is convex.

Each fence section 17 has an elongated first vertical member 28 rigidly attached to the outer face 26 of the plate 24 along the first side edge 18, and an elongated second vertical member 29 rigidly attached to the outer face 26 of the plate 24 along the second side edge 19, each extending from the bottom edge 20 to the top edge 21. A curved, elongated bottom horizontal member 30 is rigidly attached to the outer face 26 of the plate 24 along the bottom edge 20, extending from the first vertical member 28 to the second vertical member 29. A curved, elongated top horizontal member 31 is rigidly attached to the outer face 26 of the plate 24 along the top edge 21, extending from the first vertical member 28 to the second vertical member 29.

A plurality of curved, elongated intermediate horizontal members 32 are selectively spaced between the bottom edge 20 and the top edge 21 and rigidly attached to the outer face 26 of the plate 24, each extending from the first vertical member 28 to the second vertical member 29. a plurality of horizontal members 30. The spacing of the intermediate horizontal members 32 is non-uniform, being closer near the bottom edge 20 than near the top edge 21.

The fence sections 17 each have one first connector portion 35 for each intermediate horizontal member 32. Each first connector portion 35 projects outwardly and laterally from the first side edge 18. The fence sections 17 each have one second connector portion 36 for each first connector portion 35. Each second connector portion 36 projects outwardly and laterally from the second side edge 19. The first and second connector portions 35 and 36 are horizontally aligned with the respective intermediate horizontal members 32.

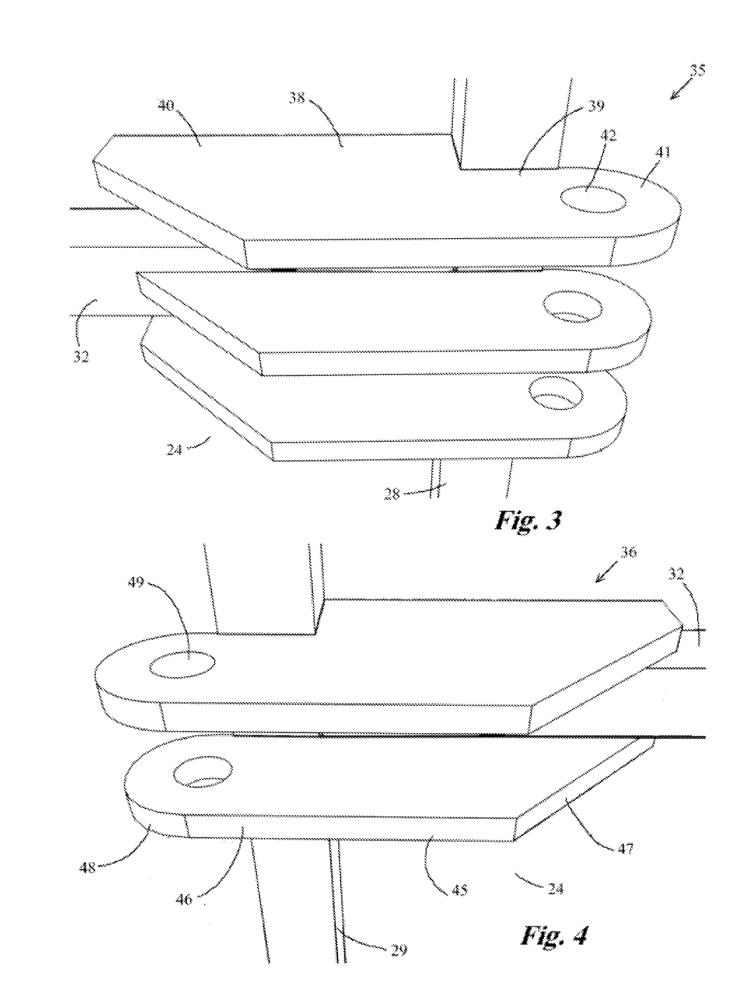

Referring to FIG. 3, the first connector portions 35 each have a plurality of horizontally spaced first leaves 38. The first leaves 38 are generally horizontal and of substantially uniform thickness. Each of the first leaves 38 has an intermediate segment 39, a brace segment 40 at one end and an end segment 41 at the opposite end. The intermediate segment 39 projects outwardly from the first vertical member 28. The end segment 41 projects laterally from the intermediate segment 39 beyond the first side edge 18 and has a rounded end. The brace segment 40 extends laterally towards the second side edge 19 and tapers inwardly. The first connector portion 35 shown has three first leaves 38, with the brace segment 40 of the upper and lower first leaves 38 attaching to the outer face 26 and the brace segment 40 of the intermediate first leaf 38 attaching to the intermediate horizontal member 32. Vertically aligned pin apertures 42, concentric with the rounded ends of the end segments 41, extends through the end segments 41 of the first leaves 38.

Referring to FIG. 4, the second connector portions 36 each have a plurality of horizontally spaced first leaves 45. The second leaves 45 are generally horizontal and of substantially uniform thickness. Each of the second leaves 45 has an intermediate segment 46, a brace segment 47 and an end segment 48. The intermediate segment 46 projects outwardly from the second vertical member 29. The end segment 48 projects laterally from the intermediate segment 46 beyond the second side edge 19 and has a rounded end. The brace segment 47 extends laterally towards the first side edge 18 and tapers inwardly. The second connector portion 36 shown has two second leaves 45, with the brace segment 47 of both second leaves 45 attaching to the outer face 26 adjacent to the intermediate horizontal member 32. Vertically aligned pin apertures 49, concentric with the rounded ends of the end segments 48, extends through the end segments 48 of the second leaves 45.

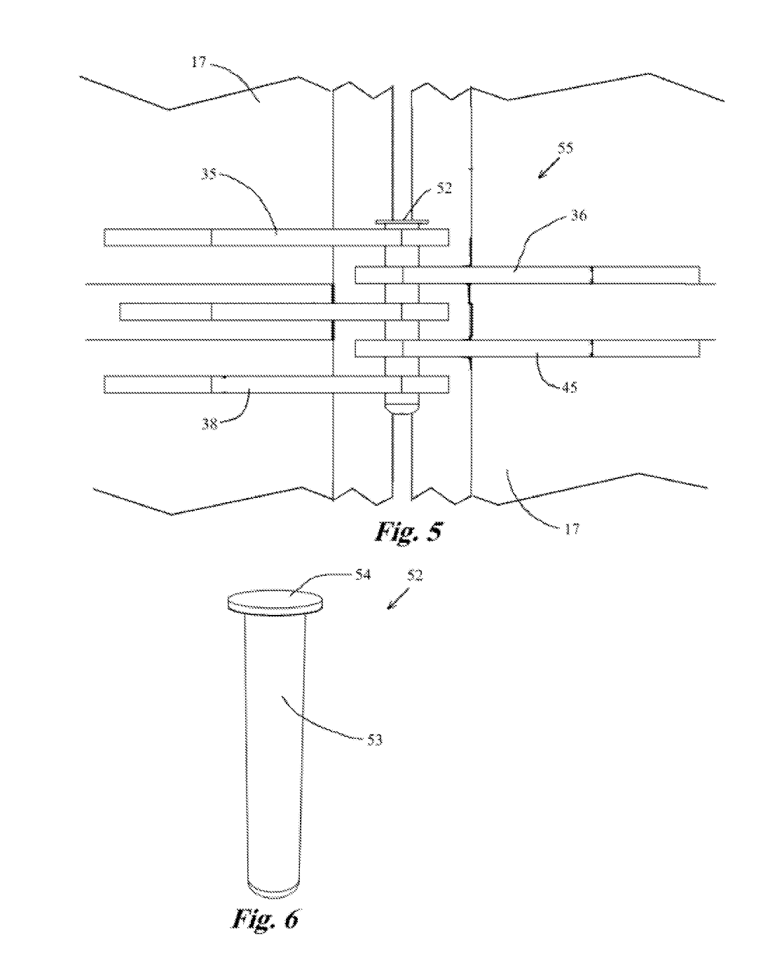

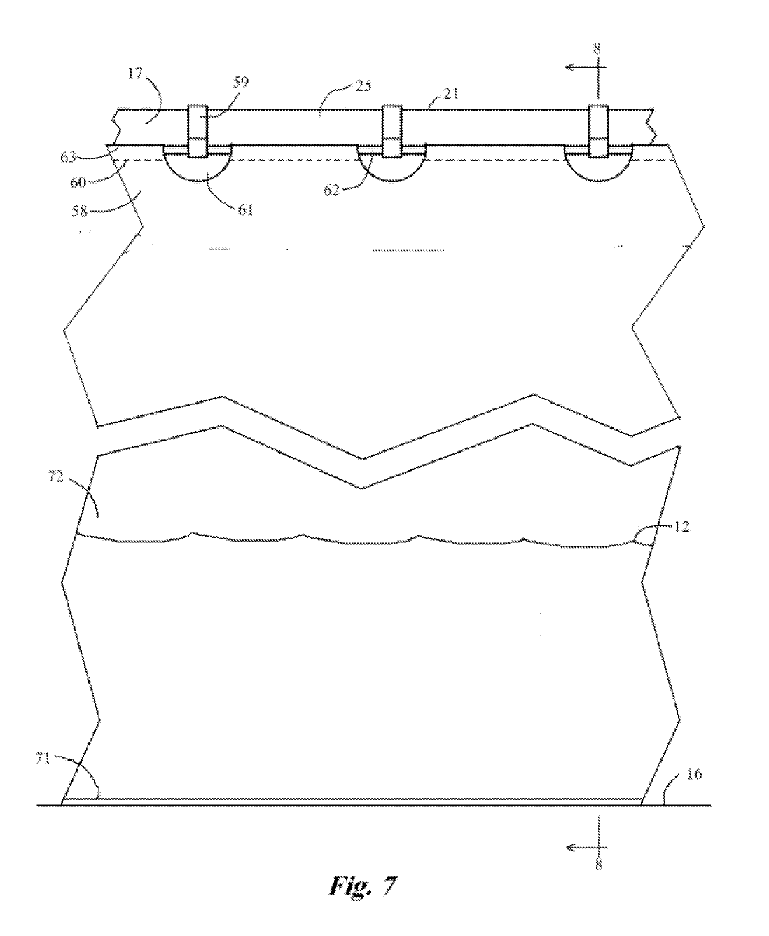

As shown in FIG. 5, when the fence sections 17 are assembled together, the first leaves 38 on the first connector portion 35 on one fence section 17 interleave with the second leaves 45 on the second connector portion 36 of the adjacent fence section 17. FIG. 6 shows a pin 52 that is provided for each interleaved pair of first and second connector portions 35 and 36 on the fence 14. The pins 52 each have cylindrical shaft 53 sized to fit through the pin apertures 42 in the first leaves 38 and the pin apertures 49 in the second leaves 45, and a projecting head 54, at one end of the shaft 53, that is larger than the pin apertures 42 in the first leaves 38 and the pin apertures 49 in the second leaves 45. Referring back to FIG. 5, the first leaves 38 on a first connector portion 35 on one fence section 17, the second leaves 45 on a second connector portion 36 of the adjacent fence section 17 that interleave with the first leaves 38 and the pin 52 through the pin apertures 42 and 49 of the first and second leaves 38 and 45 define a releasable or removable connector 55 for connecting adjacent fence sections 17 together.

Referring again to FIG. 2, each fence section 17 has two spaced lifting rings 57 attached to the outside of the bottom horizontal member 30 and two spaced lifting rings 57 attached to the outside of the top horizontal member 31. The lifting rings 57 are sized to receive a hook or clevis on rigging attached to machinery such as a front loader or crane. The lifting rings 57 on the top horizontal member 31 allow the fence section 17 to be moved into place during assembly of the fence 14. When the fence 14 is disassembled, each fence section 17 is laid down, generally with the inner face 25 of the plate 24 facing downwardly. All four lifting rings 57 are then attached to rigging to load the fence section 17 onto a flatbed trailer. Several fence sections 17 can be stacked on top of each other on a flatbed trailer.

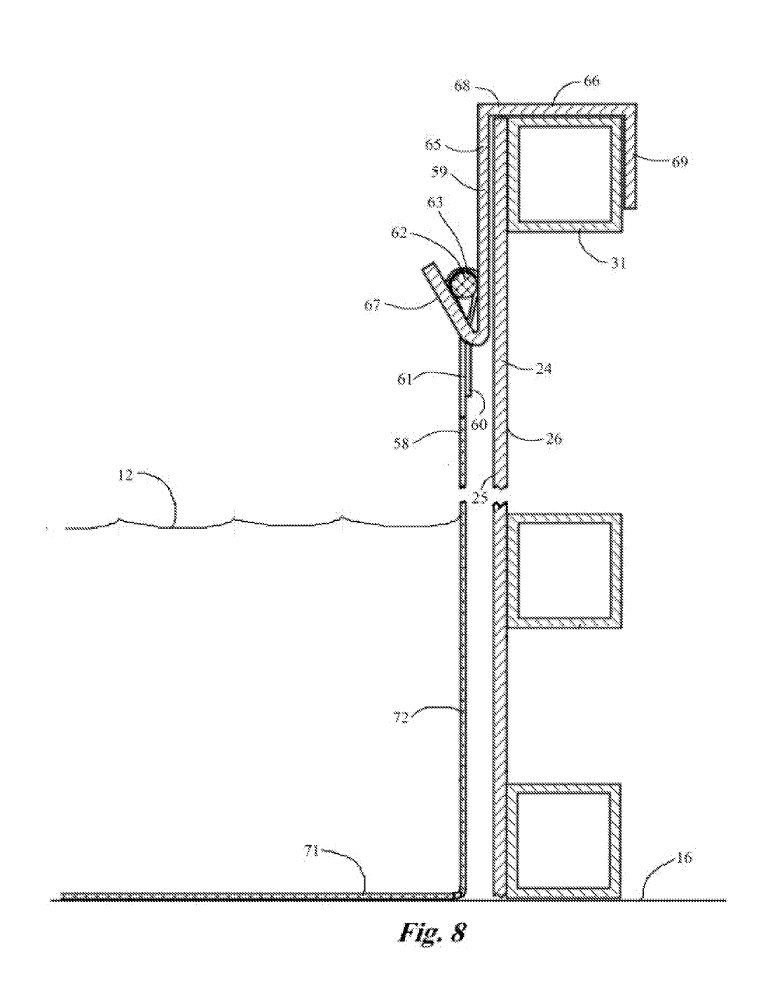

Referring to FIGS. 7 and 8, the liner 15 has a liner body 58 and a plurality of clips 59. The liner body 58 has a floor portion 71 that extends across the generally flat area of the support surface 16 that is enclosed by the fence 14, and a wall portion 72 that extends from the floor portion 71 up the inner faces 25 of the plates 24 to almost the top edge 21 of the fence sections 17. The liner body 58 is made of a thin, liquid impermeable material. By way of example, and not as a limitation, the liner body 58 can be made of 36 mil (0.036″) Reinforced Polypropylene (RPP) film. The liner body 58 has a peripheral edge 60 and a plurality of uniformly spaced, generally round apertures 61 that are spaced a selected distance inwardly from the peripheral edge 60. The liner 15 includes an endless cable or belt 62 that extends across the middle of all of the apertures 61. The peripheral edge 60 is folded over the belt 62 and attached, such as by sewing, to the liner body 58, forming a hem 63 along the outer extent of the liner body 58. After the hem 63 is formed the apertures 61 have a semi-circular shape with belt 62 closing the wide part of each aperture 61.

The clips 59 are shaped to hang over the top edge 21 of the fence sections 17, and project through the apertures 61 in the liner 15 and hang under the belt 62 to support the liner 15 on the fence 14. Each clip 59 has a vertical intermediate portion 65, an upper hook 66, and a lower hook 67. The upper hook 66 has a horizontal first segment 68 that projects outwardly from the top of the intermediate portion 65 and a vertical second segment 69 that projects downwardly from the end of the first segment 68 opposite the intermediate portion 65. The distance between the intermediate portion 65 and the second segment 69 is equal to or slightly greater than the thickness of the plate 24 and the top horizontal member 31. The lower hook 67 projects upwardly and inwardly from the bottom of the intermediate portion 65, forming a V. The clips 59 shown are made of steel strap and can be made by bending or forming. Other materials can be used and other methods of making, such as casting, molding or welding, can be used.

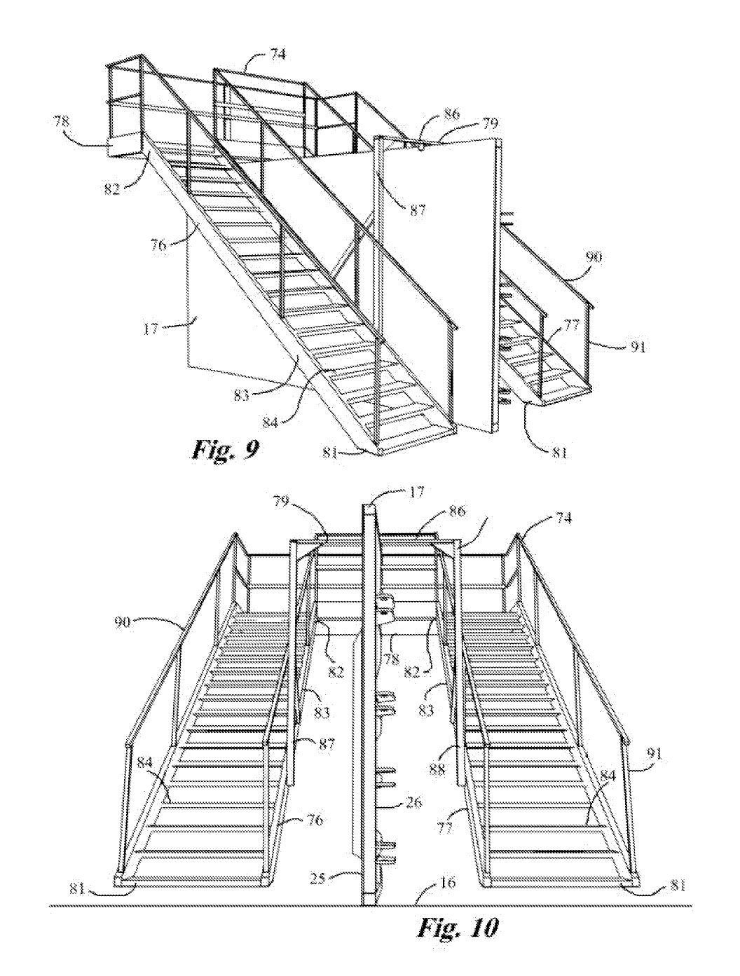

FIGS. 9 and 10 show a stile 74 that provides access between the inside and outside of the reservoir 10. The stile 74 includes an inner stairway 76, a spaced, parallel outer stairway 77, a bridge 78 and a support portion 79. The inner and outer stairways 76 and 77 each have an lower end 81, a spaced upper end 82, a pair of spaced, parallel stringers 83 that extend upwardly and laterally from the lower end 81 to the upper end 82, and a plurality of spaced, horizontal steps 84 the extend between the stringers 83.

The bridge 78 is horizontal and substantially flat. The bridge 78 connects to the upper ends 82 of the inner and outer stairways 76 and 77. The stile 74 is assembled to the reservoir 10 with the bridge 78 extending across a fence section 17 and supported by the top edge 21 of the fence section 17. The inner stairway 76 is inside the reservoir 10 and spaced inwardly from the inner face 25 of the fence section 17. The outer stairway 77 is outside the reservoir 10 and spaced outwardly from the outer face 26 of the fence section 17.

The support portion 79 is spaced from the bridge 78 towards the lower ends 81 of the inner and outer stairways 76 and 77. The support portion 79 has an elongated horizontal member 86, and spaced inner and outer upright members 87 and 88 that project downwardly from opposite ends of the horizontal member 86. The horizontal member 86 extends across the fence section 17 and is supported by the top edge 21 of the same fence section 17 that supports the bridge 78 or an adjacent fence section 17.

The inner upright member 87 attaches to the stringer 83 of the inner stairway 76 that is nearer to the inner face 25 of the fence section 17. The outer upright member 88 attaches to the stringer 83 of the outer stairway 77 that is nearer to the outer face 26 of the fence section 17. The lengths of the inner and outer upright members 87 and 88 is selected such that the support portion 79 suspends the lower ends 81 of the inner and outer stairways 76 and 77 above the floor portion 71 of the liner body 58 and above the support surface 16. A spaced pair of handrails 90 are spaced above the stringers 83 and bridge 78 by handrail posts 91. The handrails 90 extend up opposite sides of the inner stairway 76, across the bridge 78 and down opposite sides of the outer stairway 77.

By way of example, and not as a limitation, the fence 14 of the reservoir 10 can have twenty-four fence sections 17 with each fence section 17 being twenty feet long and twelve feet high, providing an enclosed volume of about 218,098 cubic feet and giving the reservoir 10 a capacity of about 1,631,492 gallons or 38,845 oil barrels (bbl). The plate 24 can be quarter inch plate. The first vertical member 28, second vertical member 29, the bottom horizontal member 30, top horizontal member 31 and the intermediate horizontal members 32 can all be 4″×4″×¼″ HSS tube. The first leaves 38 can be one inch plate and can be spaced on 4.5″ centers. The second leaves 45 can be one inch plate and can be spaced on 4.0″ centers.

The pin apertures 42 and 49 in the first and second leaves 38 and 45 can be about two inches in diameter. The shaft 53 of the pins 52 can be about twelve inches long with about a two inch diameter, and the head 54 of the pins 52 can have a diameter of about three inches. The fence sections 17 can each have four intermediate horizontal members 32 with centers spaced above the bottom edge 20 at 18″, 45″, 72″ and 108″. The intermediate horizontal members 32 are closer together lower on the fence sections 17 due to the higher fluid pressure and force lower in the reservoir 10. Two rows of six fence sections 17 each can be stacked on a trailer, so that only two trailers are needed to transport the fence 14.

By way of another example, and not as a limitation, the fence 14 of the reservoir 10 can have twelve fence sections 17 with each fence section 17 being twenty feet long and twelve feet high. This fence 14 provides an enclosed volume of about 54,048 cubic feet and gives the reservoir 10 a capacity of about 404,307 gallons or 9,626 oil barrels (bbl). This fence 14 can be transported on a single trailer.

Although the present invention has been described with a certain degree of particularity, it is understood that the present disclosure has been made by way of example and that changes in details of structure may be made without departing from the spirit thereof.

What is claimed is:

1. A portable reservoir for liquid storage comprising:
a substantially circular fence enclosing an area of a support surface and having a plurality of rigid, portable fence sections each including spaced first and second side edges, and spaced bottom and top edges that each extend from said first side edge to said second side edge, said fence sections each having a plurality of first connector portions selectively spaced along and projecting from said first side edge and a second connector portion along said second side edge opposite each first connector portion, said second connector portions each being shaped to interleave with one first connector portion on an adjacent fence section to connect said fence sections together, and
a liner including a liner body of liquid impermeable material that rests on said support surface, and extends over said area and upwardly to a peripheral edge near said top edge of said fence sections to hold liquid within said fence.

2. The reservoir as set forth in claim 1:
wherein each first connector portion includes a plurality of spaced, horizontal first leaves and each second connector portion includes a plurality of horizontal second leaves spaced to interleave with said first leaves, said first and second leaves each having a vertical pin aperture with said pin apertures being positioned to vertically align when said first and second leaves are interleaved, and
including a pin for each first connector portion, said pins being sized to fit and extend through said pin apertures of said first and second leaves,
whereby said pins connect said first and second leaves to connect said fence sections together.

3. The reservoir as set forth in claim 2 wherein said first connector portions each have one more first leaf than said second connector portions have second leaves.

4. The reservoir as set forth in claim 3 wherein said first connector portions each have three first leaves and said second connector portions each have two second leaves.

5. The reservoir as set forth in claim 2 wherein said first connector portions are selectively spaced with a non-uniform spacing with said first connector portions being more closely spaced near said bottom edge than near said top edge.

6. The reservoir as set forth in claim 5 wherein said fence sections each include a plate from said first edge to said second edge and from said bottom edge to said top edge, said plate curving from said first edge to said second edge and having a concave inner face and a spaced convex outer face, said first and second connecting portions attaching to said outer face.

7. The reservoir as set forth in claim 6 wherein said plate is steel plate.

8. The reservoir as set forth in claim 6 wherein said fence sections each include an elongated first vertical member rigidly attached to said outer face along said first side edge and an elongated second vertical member rigidly attached to said outer face along said second side edge.

9. The reservoir as set forth in claim 8 wherein said fence sections each have a curved, elongated bottom horizontal member along said bottom edge, a curved, elongated top horizontal member along said top edge, and a plurality of curved, elongated intermediate horizontal members with one said intermediate horizontal member extending horizontally from each said first connector portion, said bottom, top and intermediate horizontal members each being rigidly attached to said outer face and extending from said first vertical member to said second vertical member.

10. The reservoir as set forth in claim 1 including a plurality of spaced clips shaped to hook over said top edge of said fence sections and shaped to support said peripheral edge of said liner.

11. The reservoir as set forth in claim 10 wherein:
said liner includes an endless belt with said peripheral edge of said liner body being folded over to form a hem to enclose said belt,
said liner body includes a plurality of spaced apertures along said hem, and
said clips each include an upper hook that hooks over said top edge of said fence sections and a spaced lower hook that projects through said apertures in said liner body under said belt,
whereby said clips support said liner.

12. The reservoir as set forth in claim 1 including a stile that is supported by said top edge of said fence sections and suspended above said support surface, said stile providing access between the inside and the outside of said fence.

13. The reservoir as set forth in claim 12 wherein said stile includes a bridge that extends across said top edge of said fence sections, an inner stairway that extends downwardly and laterally from said bridge inside said fence, and a spaced outer stairway that extends downwardly and laterally from said bridge outside said fence, said inner and outer stairways each having a lower end, said stile having a support portion supported by said top edge of said fence sections and connected to said inner and outer stairways such that said support portion suspends said lower ends of said inner and outer stairways above said support surface.

14. A portable reservoir for liquid storage comprising:
a substantially circular fence enclosing an area of a support surface and having a plurality of rigid, portable fence sections each including spaced first and second side edges, and spaced bottom and top edges that each extend from said first side edge to said second side edge, each said fence section having a plate from said first edge to said second edge and from said bottom edge to said top edge, said plate curving from said first edge to said second edge and having a concave inner face and a spaced convex outer face, each said fence section having an elongated first vertical member rigidly attached to said outer face along said first side edge and an elongated second vertical member rigidly attached to said outer face along said second side edge, said fence sections each having a curved, elongated bottom horizontal member along said bottom edge, a curved, elongated top horizontal member along said top edge, and a plurality of space curved, elongated intermediate horizontal members between said bottom and top horizontal members, said bottom, top and intermediate horizontal members each being rigidly attached to said outer face and extending from said first vertical member to said second vertical member, said fence sections each having a plurality of first connector portions selectively spaced along and projecting from said first side edge and a second connector portion along said second side edge opposite each first connector portion, each first connector portion including a plurality of spaced, horizontal first leaves and each second connector portion includes a plurality of horizontal second leaves spaced to interleave with said first leaves, said first and second leaves each having a vertical pin aperture with said pin apertures being positioned to vertically align when said first and second leaves are interleaved, said fence including a pin for each said first connector portion, said pins being sized to fit and extend through said pin apertures of said first and second leaves,
a liner of including a liner body of liquid impermeable material and an endless belt, said liner body resting on said support surface, and extending over said area and upwardly to a peripheral edge near said top edge of said fence sections, said peripheral edge of said liner body being folded over to form a hem to enclose said belt, said liner body including a plurality of spaced apertures along said hem, and
a plurality of spaced clips that each include an upper hook that hooks over said top edge of said fence sections and a spaced lower hook that projects through said apertures in said liner body under said belt to support said peripheral edge.

15. A connector for connecting rigid, portable fence sections of a fence for a portable reservoir with each fence section having spaced first and second side edges, and spaced bottom and top edges that each extend from said first side edge to said second side edge, comprising:
a first connector portion, attached along said first side edge of one fence section, having a plurality of spaced, horizontal first leaves,
a second connector portion, attached along said second side edge of an adjacent fence section, having a plurality of horizontal second leaves spaced to interleave with said first leaves, said first and second leaves each having a vertical pin aperture with said pin apertures being positioned to vertically align when said first and second leaves are interleaved, and
a pin being sized to fit and extend through said pin apertures of said first and second leaves,
whereby said pin connects said first and second leaves to connect said first and second connector portions together.

16. The connector as set forth in claim 15 wherein said first connector portion has one more first leaf than said second connector portion has second leaves.

17. The connector as set forth in claim 16 wherein said first connector portion has three first leaves and said second connector portion has two second leaves.
